(19) United States
(12) Patent Application Publication
(10) Pub. No.: US 2025/0043194 A1
(43) Pub. Date: Feb. 6, 2025

(54) SYSTEMS AND PROCESSES FOR IMPROVING HYDROCARBON UPGRADING

(71) Applicant: Dow Global Technologies LLC, Midland, MI (US)

(72) Inventors: Wim Kamperman, Terneuzen (NL); Cornelis Biesheuvel, Terneuzen (NL); Bernardo M. Corripio, Baton Rouge, LA (US); Ryan C. Johnson, Rancho Cucamonga, CA (US)

(73) Assignee: Dow Global Technologies LLC, Midland, MI (US)

(21) Appl. No.: 18/718,940

(22) PCT Filed: Dec. 15, 2022
(86) PCT No.: PCT/US2022/081615

§ 371 Date: Jun. 12, 2024

Related U.S. Application Data
(60) Provisional application No. 63/290,692, filed on Dec. 17, 2021.

(51) Int. Cl. C10G 9/24

(52) U.S. Cl. CPC C10G 9/24; C10G 2300/1037; C10G 2300/4006; C10G 2300/807; C10G 2400/20; C10G 2400/30

(57) ABSTRACT

A system and process for upgrading a hydrocarbon-based composition, that includes introducing the hydrocarbon-based composition into a reaction zone heated with electricity, concentrated solar radiation heat, nuclear reactor heat, geothermal heat, molten salt, molten metal, or combinations thereof; heating the hydrocarbon-based composition in the reaction zone to create a product stream; cooling the product stream create a cooled product stream, wherein: the reaction zone does not produce flue gas.

### CROSS-REFERENCE TO RELATED APPLICATION

This application claims the benefit of and priority to U.S. Application Ser. No. 63/290,692 filed on Dec. 17, 2021, and entitled “SYSTEMS AND PROCESSES FOR IMPROVING HYDROCARBON UPGRADING,” the entire contents of which are incorporated by reference in the present disclosure.

### BACKGROUND

### Field

The present specification generally relates to systems and processes for converting a hydrocarbon-based composition to desired products while minimizing carbon dioxide (CO₂) emissions through the use of electrical heating. In particular, the present specification relates to systems and processes that use reaction zones heated via electricity.

### Technical Background

Feedstock ethane, propane, butane, naphtha, and other hydrocarbons must be upgraded before they can be used as a commercially valuable product, such as hydrogen, olefins, and aromatic hydrocarbons. This upgrading process conventionally utilizes a reactor system in which combustion-such as, for example, combustion of methane—is used to heat a hydrocarbon-based composition converting the hydrocarbon-based composition to a product stream comprising desired products. Furthermore, the combustion furnace of conventional reactor systems produces additional CO₂ emissions.

Accordingly, a need exists for systems and processes for converting hydrocarbon-based compositions to desired products while reducing CO₂ emissions.

### SUMMARY

According to one embodiment of the present disclosure, a system for upgrading a hydrocarbon-based composition comprises: a reaction vessel comprising a heating column, a heat recovery exchanger comprising molten salt, molten metal, organic fluid, as heat transfer medium, or without intermediate fluid heat transfer, or combinations thereof, and an electric heater, wherein: the heating column is thermally connected to the electric heater; and the heating column is thermally connected to the heat recovery exchanger.

According to another embodiment of the present disclosure, a process for upgrading a hydrocarbon-based composition comprises: introducing the hydrocarbon-based composition into a reaction zone heated with electricity, concentrated solar radiation heat, nuclear reactor heat, geothermal heat, molten salt, molten metal, or combinations thereof, heating the hydrocarbon-based composition in the reaction zone to create a product stream; cooling the product stream to create a cooled product stream, wherein: the reaction zone does not product flue gas.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a system and process for upgrading a hydrocarbon-based composition to desired products according to embodiments disclosed and described herein.

FIG. 2 schematically depicts a system and process for upgrading a hydrocarbon-based composition to desired products according to embodiments disclosed and described herein.

### DETAILED DESCRIPTION

Reference will now be made in detail to embodiments of systems and processes for upgrading hydrocarbon-based compositions to desired products, such as, for example, at least one of hydrogen, olefins, or aromatic hydrocarbons, embodiments of which are illustrated in the accompanying drawings. Whenever possible, the same reference numerals will be used throughout the drawings to refer to the same or like parts.

In one embodiment, a system for upgrading a hydrocarbon-based composition comprises: a reaction vessel comprising a heating column, a heat recovery exchanger comprising molten salt, molten metal, organic fluid, as heat transfer medium, or without intermediate fluid heat transfer, or combinations thereof, and an electric heater, wherein: the heating column is thermally connected to the electric heater; and the heating column is fluidly connected to the heat recovery exchanger. One or more of these systems may be replaced by another type of heat exchanger.

In another embodiment, a process for upgrading a hydrocarbon-based composition comprises: introducing the hydrocarbon-based composition into a reaction zone; heating the hydrocarbon-based composition in the reaction zone to create a product stream; cooling the product stream to create a cooled product stream, wherein: the reaction zone is heated via electricity.

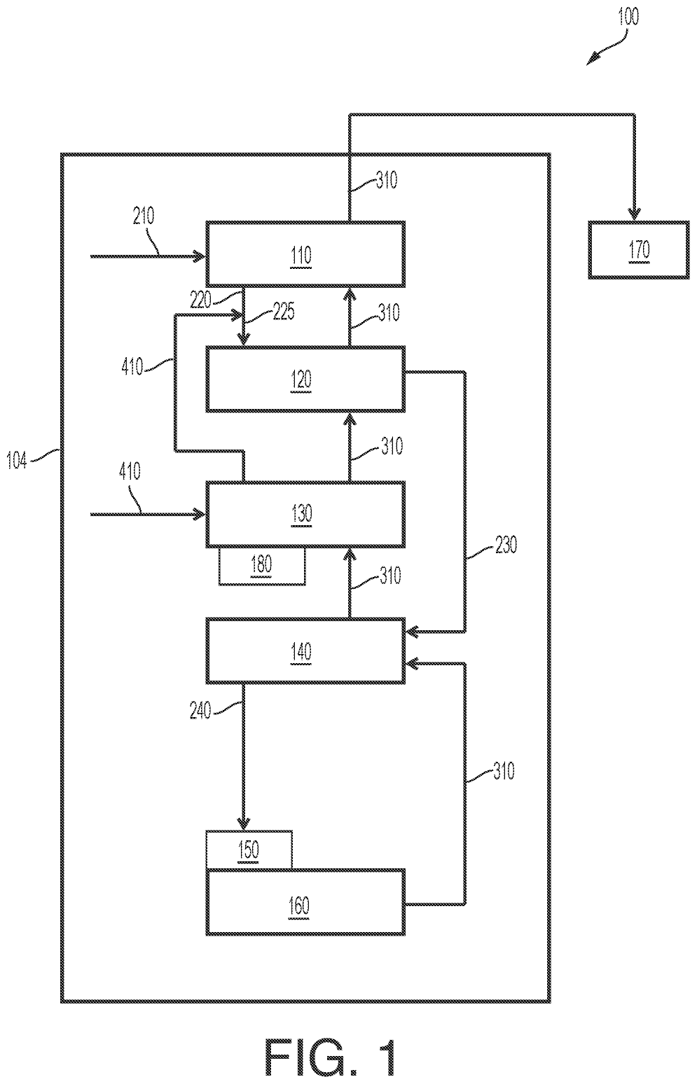

With reference now to FIG. 1, an embodiment of a system for converting hydrocarbon-based compositions to desired products is provided. It should be understood that the embodiment depicted in FIG. 1 is exemplary and does not limit the scope of this disclosure. As shown in the embodiment depicted in FIG. 1, a system 100 for converting a hydrocarbon-based composition 240 to a product stream 310 that comprises desired products includes, in series and/or in parallel, a feed pre-heat unit 110, a first hydrocarbon heat unit 120, a dilution steam heat unit 130, a second hydrocarbon heat unit 140, an electric heater 150, and a reaction zone 160. It should be understood that according to various embodiments, the system 100 may include various combinations of the above-listed components of the system 100. Furthermore, the system 100 may comprise one or more heat exchangers, which may be thermally coupled to one another, in series and/or in parallel.

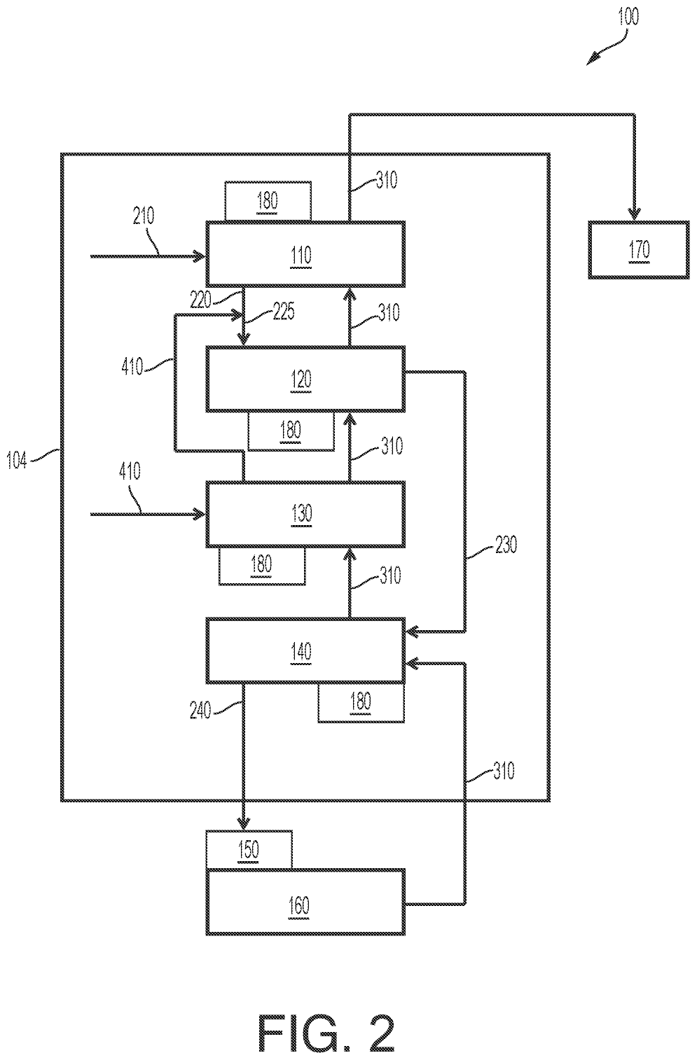

As shown in FIG. 1, in embodiments, a reaction zone 160 may be a portion of the heating column 104 that is capable of creating reaction conditions as defined herein. However, in embodiments, the reaction zone 160 may be outside the heating column 104 and may be fluidly connected to the heating column 104, as shown in FIG. 2. The reaction zone 160 may operate at a temperature ranging from 600° C. to 1200° C., such as from 800° C. to 1000° C., from 850° C. to 950° C., or from 825° C. to 900° C.; and a pressure that is greater than 0 bar gauge (0 kPa gauge), such as at least 0.5 bar (50 kPa), or at least 1 bar (100 kPa). The lower the operating pressure the better for selectivity. Operating pressure is limited by downstream pressure drop and the desire typically to run the downstream process at above atmospheric pressure. In embodiments, the operating pressure in the reaction zone may be at any value greater than 0 bar gauge (0 kPa gauge). In some embodiments, the reaction zone 160 may operate at a gauge pressure of from 0.5 to 3 bar (from 50 to 300 kPa), from 1 to 3 bar (from 100 to 300 kPa), from 2 to 3 bar (from 200 to 300 kPa), from 0.5 to 2 bar (from 50 to 200 kPa), from 1 to 2 bar (from 100 to 200 kPa), or from 0.5 to 1 bar (from 50 to 100 kPa).

In some embodiments, the duty (or power) required for the reaction within the reaction zone 160 may range from 20 Gigacalories per hour (Gcal/hr) to 50 Gcal/hr, from 20 Gcal/hr to 40 Gcal/hr, from 20 Gcal/hr to 35 Gcal/hr, from 20 Gcal/hr to 32 Gcal/hr, from 25 Gcal/hr to 50 Gcal/hr, from 25 Gcal/hr to 40 Gcal/hr, from 25 Gcal/hr to 35 Gcal/hr, from 25 Gcal/hr to 32 Gcal/hr, from 30 Gcal/hr to 50 Gcal/hr, from 30 Gcal/hr to 40 Gcal/hr, from 30 Gcal/hr to 35 Gcal/hr, or from 30 Gcal/hr to 32 Gcal/hr. It is understood that the duty required for the reaction may be proportional with throughput, according to embodiments.

The systems and processes for converting hydrocarbon-based compositions to desired products as disclosed herein address the need for reducing CO₂ emissions heating the at least one reaction zone 160 through electrical heating; or direct or indirect heat input via convection, conduction, or thermal radiation. Some examples include concentrated solar radiation heat, nuclear reactor heat, geothermal heat, or stored heat in molten salt or molten metal. In embodiments, an electric heater 150 heats hydrocarbon-based composition 240 to the desired reaction zone 160 inlet temperature of approximately 600° C. Conventional combustion reactors produce flue gas (having a temperature that is generally greater than 600° C.) as a by-product from the combustion. In conventional upgrading systems and processes, the flue gas comprises approximately 60% of the heat and energy input of the combustion reaction, thereby producing significant inefficiencies. As the flue gas is a natural consequence of the combustion reaction and has approximately 60% of the energy of the reaction, heat from the flue gas is conventionally utilized upstream of the conversion reaction zone to heat the hydrocarbon-based composition prior to reaction and to heat dilution steam streams. Because the reaction zones as disclosed herein do not create flue gas, the systems and the processes of the present disclosure incorporate new process designs to heat the hydrocarbon-based composition prior to reaction and to heat dilution steam streams.

In some embodiments, the reactor system 100 is connected to a source of electrical current that provides electrical current to the reactor system 100 through electrical lead lines. In embodiments, the heating column 104 may include at least one trim temperature controller 180. In embodiments, the trim temperature controller 180 may be a trim heater or a trim cooler configured to heat or cool. In embodiments, the trim heater 180 may be a single unit to either heat or cool, in other embodiments heating and cooling may be provided by separate units. In embodiments, the trim heater may be electrically driven. The electrical current may be supplied to the electric heater 150, the trim heater, or combinations thereof. The electrical lead lines transfer the electrical current from the source of electrical current to the electric heater 150, the at least one trim temperature controller 180, or both via an electrical connection between the source of electrical current and the electric heater 150, the at least one trim temperature controller 180, or both. In various embodiments, the source of electrical current may be a renewable energy source, leading to no CO₂ emissions. The source of electrical current may, in embodiments, be nuclear power, steam energy, natural gas, coal, or the like. The source of electrical current may, in embodiments, be a renewable source, such as a battery, solar power, wind energy, hydroelectric power, or the like. The electrical current may be decreased or increased outside of the system 100. In some embodiments, the electrical current may be actively controlled, turned on and off, and decreased or increased to control the heat generated in the electric heater 150, the at least one trim temperature controller 180, or both.

In some embodiments, the heating column 104 of the reactor system 100 comprises one reaction zone 160 (as shown). In some embodiments, the heating column 104 comprises at least two reaction zones 160 (additional reaction zones not shown). The at least two reaction zones 160 may be configured in parallel or in series. Each of these at least two reaction zones 160 may independently receive electrical current. The voltage of the electrical current that may be converted to heat along with the specific amperes of the electrical current are indicative of the heat of the reaction zone 160. Specifically, the temperature of the reaction zone 160 during the process of converting the hydrocarbon-based composition 240 may be determined from the values of the resistivity of an electric heater heating the reaction zone 160 and the amperes of the electrical current that is converted to heat in the electric heater 150. Joule's first law states that the power (P) of heating generated by an electrical conductor is proportional to the product of its resistance (R) and the square of the current (I), as shown by Equation 1:

$$P ∝ {I}^{2} R \qquad ( 1 )$$

According to embodiments, one or more additional components may be included in the reactor system 100. In embodiments, such as shown in FIG. 1, the heating column 104 may further include a feed pre-heat unit 110, a first hydrocarbon heat unit 120, a dilution steam heat unit 130, and a second hydrocarbon heat unit 140. The first hydrocarbon heat unit 120 may be fluidly connected to the feed pre-heat unit 110, the dilution steam heat unit 130, and the second hydrocarbon heat unit 140. The second hydrocarbon heat unit 140 may be fluidly connected to the dilution steam heat unit 130, the first hydrocarbon heat unit 120, and a reaction zone 160. The feed pre-heat unit 110, the first hydrocarbon heat unit 120, the dilution steam heat unit 130, and the second hydrocarbon heat unit 140 may function as heat exchangers. There may be one or more heat exchangers within the system 100, which may be parallel and/or in series. The heat exchangers may minimize the electrical energy consumption of the system. As previously described, the heating column 104 may further include at least one trim temperature controller 180. The trim temperature controller 180 may be thermally connected to at least one of the feed pre-heat unit 110, the first hydrocarbon heat unit 120, the dilution steam heat unit 130, or the second hydrocarbon heat unit 140. FIG. 1 shows the trim temperature controller 180 thermally connected to only the dilution steam heat unit 130, however, this should be understood as solely an example embodiment. As shown in FIG. 2, there may be trim temperature controllers 180 connected to each of the feed pre-heat unit 110, the first hydrocarbon heat unit 120, the dilution steam heat unit 130, or the second hydrocarbon heat unit 140. Therefore, it should be understood that the trim temperature controller 180 may be connected or not connected to any of the feed pre-heat unit 110, the first hydrocarbon heat unit 120, the dilution steam heat unit 130, or the second hydrocarbon heat unit 140 as necessary. In embodiments, the trim temperature controller 180 may be a trim heater or a trim cooler configured to heat or cool at least one of the feed pre-heat unit 110, the first hydrocarbon heat unit 120, the dilution steam heat unit 130, or the second hydrocarbon heat unit 140 as needed. In embodiments, trim temperature controller 180 may be electrically heated and cooled by other means. The trim temperature controller 180 operates to heat or cool any of the feed pre-heat unit 110, the first hydrocarbon heat unit 120, the dilution steam heat unit 130, or the second hydrocarbon heat unit 140 to optimize heating and cooling efficiency within the system.

According to one or more embodiments, a process for converting a hydrocarbon-based composition 240 to desired products such as, for example, a product stream 310 comprising at least one of hydrogen, olefins, or aromatic hydrocarbons that uses the system 100 depicted in the embodiment of FIG. 1 will now be described. A hydrocarbon-based composition 240 is introduced into the reaction zone 160. It should be understood that the hydrocarbon-based composition 240 may comprise at least one of naphtha or heavier hydrocarbons mixtures, methane, ethane, propane, butane, pentane, water, and low levels of CO₂, CO, N₂, and H₂, according to various embodiments. In embodiments, naphtha may include atmospheric gasoil, vacuum gasoil, or both, as nonlimiting examples. In embodiments, butane may include n-butane, i-butane, or both, as nonlimiting examples. In some embodiments, the hydrocarbon-based composition 240 comprises C₁ to C₅ hydrocarbons. In other embodiments, the hydrocarbon-based composition 240 comprises C₁ to C₂₀ hydrocarbons. In yet another embodiment, the hydrocarbon-based composition 240 comprises C₁ to C₅₀ hydrocarbons.

Although the temperature at which the reaction zone 160 is operated is not particularly limited so long as it can drive the reactions for converting the hydrocarbon-based composition 240 to the desired products such as, for example, hydrogen, olefins, aromatic hydrocarbons, or combinations thereof. In embodiments, the reaction zone 160 may convert the hydrocarbon-based composition 240 comprising at least C₂ hydrocarbons to a product stream 310 comprising at least C₂ olefins. In one or more embodiments, the reaction zone 160 is operated at a temperature from 600 degrees Celsius (° C.) to 850° C., such as from 825° C. to 845° C., or about 840° C. Likewise, the pressure at which the reaction zone 160 is operated is not particularly limited so long as it can drive the above reactions, in one or more embodiments, the reaction zone 160 is operated at a pressure of from 0.3 to 3 bar(g) (from 30 to 300 kPa), from 1 to 3 bar(g) (from 100 to 300 kPa), from 2 to 3 bar(g) (from 200 to 300 kPa), from 0.5 to 2 bar(g) (from 50 to 200 kPa), from 1 to 2 bar(g) (from 100 to 200 kPa), or from 0.5 to 1 bar(g) (from 50 to 100 kPa).

Lastly, the process comprises converting the hydrocarbon-based composition 240 to a product stream 310 within the reaction zone 160, and removing the product stream 310 from the reaction zone 160. Converting the hydrocarbon-based composition 240 to the product stream 310 may comprise increasing the temperature of the hydrocarbon-based composition 240, thereby causing a chemical reaction that produces the product stream 310. The hydrocarbon-based composition 240 may be heated by the electric heater 150 under reaction conditions sufficient to form a product stream 310. The reaction conditions may comprise: a temperature from 600 degrees Celsius (° C.) to 850° C., such as from 825° C. to 845° C., or about 840° C.; and at a pressure of from 0.3 to 3 bar (from 30 to 300 kPa), from 1 to 3 bar (from 100 to 300 kPa), from 2 to 3 bar (from 200 to 300 kPa), from 0.5 to 2 bar (from 50 to 200 kPa), from 1 to 2 bar (from 100 to 200 kPa), or from 0.5 to 1 bar (from 50 to 100 kPa) In some embodiments, the electric heater 150 is heated to a temperature of greater than 500° C., greater than 600° C., greater than 700° C., greater than 750° C., greater than 800° C., greater than 850° C., greater than 900° C., greater than 950° C., or greater than 1000° C. The reactions that occur in the reaction zone 160 produce a product stream 310. In some embodiments, the reactions that occur further produce byproducts comprising one or more of CO, CO₂, H₂, H₂O, CH₄, C₂H₆, C₂H₂, C₃H₆, C₃H₈, and C₃H₄. The temperature of the product stream 310 leaving the reaction zone 160 may be from 750° C. to 900° C., from 780° C. to 900° C., from 800° C. to 900° C., from 850° C. to 900° C., from 860° C. to 900° C., from 870° C. to 900° C., from 880° C. to 900° C., from 890° C. to 900° C., from 750° C. to 890° C., from 780° C. to 890° C., from 800° C. to 890° C., from 850° C. to 890° C., from 860° C. to 890° C., from 870° C. to 890° C., from 880° C. to 890° C., from 750° C. to 880° C., from 780° C. to 880° C., from 800° C. to 880° C., from 850° C. to 880° C., from 860° C. to 880° C., from 870° C. to 880° C., from 750° C. to 870° C., from 780° C. to 870° C., from 800° C. to 870° C., from 850° C. to 870° C., from 860° C. to 870° C., or approximately 860° C.

The product stream 310 comprises at least one of hydrogen, olefins, and aromatic hydrocarbons. In one or more embodiments, the product stream 310 consists essentially of or consists of at least one of hydrogen, olefins, and aromatic hydrocarbons. In embodiments, the olefins comprise C₂ to C₅ olefins such as, for example, ethylene (C₂H₄), propylene (C₃H₆), butylene (C₄H₈), butadiene (C₄H₆), or combinations thereof. In embodiments, butylene may include 1-butylene, 2-butylene, i-butylene, or combinations thereof, as nonlimiting examples. In other embodiments, the olefins comprise C₂ to C₁₀ olefins. The olefins may comprise C₂ to C₂₀ olefins. In yet another embodiment, the olefins may comprise C₂ to C₅₀ olefins. The aromatic hydrocarbons may comprise benzene and derivatives thereof, such as toluene, ethylbenzene, o-xylene, p-xylene, m-xylene, mesitylene, durene, 2-phenylhexane, and biphenyl. The product stream 310 is collected and separated or purified in various other processes to make desired intermediate and end products.

The process may further comprise pre-heating the hydrocarbon-based composition 240 before introducing the hydrocarbon-based composition 240 to the reaction zone 160. As discussed previously, flue gas produced from conventional combustion reactions is conventionally used to heat the hydrocarbon-based composition prior to reaction. However, as the systems and processes of the present disclosure do not use conventional combustion reactions to heat the reaction zone 160, there is no flue gas present in the systems and processes disclosed herein. Therefore, the absence of flue gas opens the path for new process designs to heat the hydrocarbon-based composition prior to reaction. One or more heat exchangers may be present, such as the feed pre-heat unit 110, the first hydrocarbon heat unit 120, the dilution steam heat unit 130, and the second hydrocarbon heat unit 140, where the product stream 310 (which has a temperature greater than the hydrocarbon-based composition 240 before the hydrocarbon-based composition 240 enters the reaction zone 160) may be passed through one or more of the feed pre-heat unit 110, the first hydrocarbon heat unit 120, the dilution steam heat unit 130, and the second hydrocarbon heat unit 140, which is described in more detail below, to heat the hydrocarbon-based composition 240, any stream precursor to the hydrocarbon-based composition, the dilution steam stream 410, or combinations thereof. By using the heat of the product stream 310 to heat other streams within the heating column 104, the overall efficiency of the process is increased by reusing the energy of the reaction. In embodiments, the systems and processes of the present disclosure may require less than 99%, less than 95%, less than 90%, less than 85%, less than 80%, less than 75%, less than 70%, less than 65%, or less than 62% of the power of conventional hydrocarbon upgrading systems and processes that use conventional gas fired combustion reactions. By using heat this way, stack losses from a conventional gas fired furnace may be eliminated and result in an energy saving of approximately 10%. Eliminating high pressure steam production results in an energy input saving of the furnace of up 40%. As high pressure steam production is needed, downstream process compressors may switch from steam turbine drives to electromotor drives. In embodiments, the systems and processes of the present disclosure may require from 50% to 99%, from 50% to 95%, from 50% to 90%, from 50% to 85%, from 50% to 80%, from 50% to 75%, from 50% to 70%, from 50% to 65%, from 50% to 62%, from 55% to 99%, from 55% to 95%, from 55% to 90%, from 55% to 85%, from 55% to 80%, from 55% to 75%, from 55% to 70%, from 55% to 65%, from 55% to 62%, from 60% to 99%, from 60% to 95%, from 60% to 90%, from 60% to 85%, from 60% to 80%, from 60% to 75%, from 60% to 70%, from 60% to 65%, or from 60% to 62% of the power of conventional hydrocarbon upgrading systems and processes that use conventional gas fired combustion reactions.

In embodiments, the process includes passing a feed stream 210 through a feed pre-heat unit 110 to create a pre-heated hydrocarbon-based composition 220. The temperature of the feed stream 210 before introduced to the feed pre-heat unit 110 may be from 50° C. to 110° C., from 60° C. to 110° C., from 70° C. to 110° C., from 80° C. to 110° C., from 90° C. to 110° C., from 100° C. to 110° C., from 50° C. to 100° C., from 60° C. to 100° C., from 70° C. to 100° C., from 80° C. to 100° C., from 90° C. to 100° C., from 50° C. to 90° C., from 60° C. to 90° C., from 70° C. to 90° C., from 80° C. to 90° C., from 50° C. to 80° C., from 60° C. to 80° C., from 70° C. to 80° C., from 50° C. to 70° C., from 60° C. to 70° C., or from 50° C. to 60° C. The exit temperature of the pre-heated hydrocarbon-based composition 220 from the feed pre-heat unit 110 may be below the operating temperature of the reaction zone 160. The exit temperature of the pre-heated hydrocarbon-based composition 220 from the feed pre-heat unit 110 may be from 150° C. to 300° C., from 150° C. to 275° C., from 150° C. to 250° C., from 150° C. to 225° C., from 150° C. to 220° C., from 150° C. to 200° C., from 150° C. to 175° C., from 175° C. to 300° C., from 175° C. to 275° C., from 175° C. to 250° C., from 175° C. to 225° C., from 175° C. to 220° C., from 175° C. to 200° C., from 200° C. to 300° C., from 200° C. to 275° C., from 200° C. to 250° C., from 200° C. to 225° C., from 200° C. to 220° C., from 220° C. to 300° C., from 220° C. to 275° C., from 220° C. to 250° C., from 220° C. to 225° C., from 225° C. to 300° C., from 225° C. to 275° C., from 225° C. to 250° C., from 250° C. to 300° C., from 250° C. to 275° C., or from 275° C. to 300° C. The feed pre-heat unit 110 can be used to remove heat from the product stream 310, wherein the heat removed from the product stream 310 can be used to pre-heat the hydrocarbon-based composition 240. The feed pre-heat unit 110 may cool the product stream 310 to below the reaction temperature. Cooling the product stream 310 below the reaction temperature prevents further reactions, or conversion, of the product stream 310. The feed pre-heat unit 110 may cool the product stream 310 to from 300° C. to 500° C., from 300° C. to 450° C., from 300° C. to 425° C., from 300° C. to 405° C., from 300° C. to 400° C., from 300° C. to 375° C., from 300° C. to 350° C., from 350° C. to 500° C., from 350° C. to 450° C., from 350° C. to 425° C., from 350° C. to 405° C., from 350° C. to 400° C., from 350° C. to 375° C., from 375° C. to 500° C., from 375° C. to 450° C., from 375° C. to 425° C., from 375° C. to 405° C., from 375° C. to 400° C., from 400° C. to 500° C., from 400° C. to 450° C., from 400° C. to 425° C., from 400° C. to 405° C., from 425° C. to 500° C., from 425° C. to 450° C., or from 450° C. to 500° C. This may be an optional component to the systems and processes disclosed herein, as the hydrocarbon-based composition 240 need not be pre-heated prior to introducing the hydrocarbon-based composition 240 to the electric heater 150 or the reaction zone 160, when the hydrocarbon-based composition 240 is a vapor stream.

In embodiments, the process may further comprise of mixing heated dilution steam 410 from dilution steam heat unit 130 with pre-heated composition 220 from feed pre-heater 110, resulting in mixed hydrocarbons based composition 225, followed by heating the mixed hydrocarbons based composition 225 by introducing the mixed hydrocarbons based composition 225 into the first hydrocarbon heat unit 120 to create a heated hydrocarbon-based composition 230. In embodiments where heated dilution steam 410 is not mixed with pre-heated composition 220, the process may include heating the pre-heated composition 220 by introducing the pre-heated composition 220 into the first hydrocarbon heat unit 120 to create a heated hydrocarbon-based composition 230. The exit temperature of the heated hydrocarbon-based composition 230 from the first hydrocarbon heat unit 120 may be below the operating temperature of the reaction zone 160. The exit temperature of the heated hydrocarbon-based composition 230 from the first hydrocarbon heat unit 120 may be from 300° C. to 500° C., from 300° C. to 450° C., from 300° C. to 425° C., from 300° C. to 400° C., from 300° C. to 375° C., from 300° C. to 350° C., from 300° C. to 325° C., from 325° C. to 500° C., from 325° C. to 450° C., from 325° C. to 425° C., from 325° C. to 400° C., from 325° C. to 375° C., from 325° C. to 350° C., from 350° C. to 500° C., from 350° C. to 450° C., from 350° C. to 425° C., from 350° C. to 400° C., from 350° C. to 375° C., from 375° C. to 500° C., from 375° C. to 450° C., from 375° C. to 425° C., from 375° C. to 400° C., from 400° C. to 500° C., from 400° C. to 450° C., from 400° C. to 425° C., from 425° C. to 500° C., from 425° C. to 450° C., or from 450° C. to 500° C. The first hydrocarbon heat unit 120 can be used to remove heat from the product stream 310, wherein the heat removed from the product stream 310 can be used to heat the pre-heated hydrocarbon-based composition 240. The first hydrocarbon heat unit 120 may cool the product stream 310 to below the reaction temperature. Cooling the product stream 310 below the reaction temperature prevents further reactions, or conversion, of the product stream 310. The first hydrocarbon heat unit 120 may cool the product stream 310 to from 450° C. to 600° C., from 450° C. to 575° C., from 450° C. to 550° C., from 450° C. to 525° C., from 450° C. to 500° C., from 450° C. to 475° C., from 475° C. to 600° C., from 475° C. to 575° C., from 475° C. to 550° C., from 475° C. to 525° C., from 475° C. to 500° C., from 500° C. to 600° C., from 500° C. to 575° C., from 500° C. to 550° C., from 500° C. to 525° C., from 525° C. to 600° C., from 525° C. to 575° C., from 525° C. to 550° C., from 550° C. to 600° C., from 550° C. to 575° C., or from 575° C. to 600° C. This may similarly be an optional component to the systems and processes disclosed herein.

The process may further comprise heating the heated hydrocarbon-based composition 230 by introducing the pre-heated hydrocarbon-based composition 220 into the second hydrocarbon heat unit 140 to create the hydrocarbon-based composition 240. The exit temperature of the hydrocarbon-based composition 240 from the second hydrocarbon heat unit 140 may be below the operating temperature of the reaction zone 160. The exit temperature of the hydrocarbon-based composition 240 from the second hydrocarbon heat unit 140 may be from 450° C. to 600° C., from 450° C. to 575° C., from 450° C. to 550° C., from 450° C. to 525° C., from 450° C. to 500° C., from 450° C. to 475° C., from 475° C. to 600° C., from 475° C. to 575° C., from 475° C. to 550° C., from 475° C. to 525° C., from 475° C. to 500° C., from 500° C. to 600° C., from 500° C. to 575° C., from 500° C. to 550° C., from 500° C. to 525° C., from 525° C. to 600° C., from 525° C. to 575° C., from 525° C. to 550° C., from 550° C. to 600° C., from 550° C. to 575° C., or from 575° C. to 600° C. The second hydrocarbon heat unit 140 can be used to remove heat from the product stream 310, wherein the heat removed from the product stream 310 can be used to heat the heated hydrocarbon-based composition 240. The second hydrocarbon heat unit 140 may quickly cool the product stream 310 to below the reaction temperature. Cooling the product stream 310 below the reaction temperature prevents further reactions, or conversion, of the product stream 310. The second hydrocarbon heat unit 140 may cool the product stream 310 to from 600° C. to 800° C., from 600° C. to 750° C., from 600° C. to 725° C., from 600° C. to 700° C., from 600° C. to 675° C., from 600° C. to 650° C., from 600° C. to 625° C., from 625° C. to 800° C., from 625° C. to 750° C., from 625° C. to 725° C., from 625° C. to 700° C., from 625° C. to 675° C., from 625° C. to 650° C., from 650° C. to 800° C., from 650° C. to 750° C., from 650° C. to 725° C., from 650° C. to 700° C., from 650° C. to 675° C., from 675° C. to 800° C., from 675° C. to 750° C., from 675° C. to 725° C., from 675° C. to 700° C., from 700° C. to 800° C., from 700° C. to 750° C., from 700° C. to 725° C., from 725° C. to 800° C., from 725° C. to 750° C., or from 750° C. to 800° C. In some embodiments, the second hydrocarbon heat unit 140 cools the product stream 310 to below 800° C., below 700° C., below 600° C., or below 500° C. within 1000 milliseconds, 500 milliseconds, 200 milliseconds, 100 milliseconds, or 50 milliseconds. This may similarly be an optional component to the systems and processes disclosed herein.

In some embodiments, the process further comprises removing heat from the product stream 310 after removing the product stream 310 from the reaction zone 160 by passing the product stream 310 through a dilution steam heat unit 130. The dilution steam heat unit 130 may cool the product stream 310 to below the reaction temperature. Cooling the product stream 310 quickly below the reaction temperature prevents further reactions, or conversion, of the product stream 310. In some embodiments, the dilution steam heat unit 130 cools the product stream 310 to below 600° C., or below 500° C. The process may further comprise passing a dilution steam stream 410 through the dilution steam heat unit 130. The temperature of the dilution steam stream 410 before being introduced to the dilution steam heat unit 130 may be from 150° C. to 200° C., from 160° C. to 200° C., from 170° C. to 200° C., from 180° C. to 200° C., from 190° C. to 200° C., from 150° C. to 190° C., from 160° C. to 190° C., from 170° C. to 190° C., from 180° C. to 190° C., from 150° C. to 180° C., from 160° C. to 180° C., from 170° C. to 180° C., from 150° C. to 170° C., from 160° C. to 170° C., from 150° C. to 160° C., or approximately 175° C. The process may comprise cooling the product stream 310 in the dilution steam heat unit 130 with the dilution steam stream 410. In embodiments, the process may further comprise passing the dilution steam stream 410 from the dilution steam heat unit 130 to mix with the pre-heated hydrocarbon-based composition 220, thereby transferring heat from the dilution steam stream 410 to the pre-heated hydrocarbon-based composition 220. Passing the dilution steam stream 410 may increase the energy efficiency of the system 100. Additionally, it is contemplated that mixing the dilution steam stream 410 with the pre-heated hydrocarbon-based composition 220 before introducing the pre-heated hydrocarbon-based composition 220 to the first hydrocarbon heat unit 120 may prevent condensation. These are optional components to the systems and processes disclosed herein, as the product stream 310 may be cooled according to other methods known in the art.

In embodiments, the process may further include cooling the product stream 310 in a heat recovery exchanger 170. The heat recovery exchanger 170 may include a heat exchanger with molten salt, molten metal, organic fluid, or water as heat transfer medium, a spray nozzle, a quench column, direct heat transfer, or combinations thereof. In embodiments, the product stream 310 may have been cooled to below reaction temperature before being introduced to the heat recovery exchanger 170. In embodiments, the product stream 310 may not have been cooled to below reaction temperature before being introduced to the heat recovery exchanger 170, and this may serve as a quenching step. Quenching the product stream 310 below the reaction temperature prevents further reactions, or conversion, of the product stream 310 to quickly stop such reactions and conversions in the product stream. It should be understood that the term “cool” is used throughout this disclosure to describe various steps wherein the streams described herein are cooled and may encompass steps in which a stream is quenched. The term “cool” is not meant to be limiting, and instead, is meant to encompass embodiments in which a stream is quenched to stop reactions or conversions within the stream. When the cooling step includes direct heat transfer, the process may further comprise passing a cold coolant stream (not shown) through a coolant drum (not shown) and then to the heat recovery exchanger 170. The process may comprise cooling the product stream 310 in the heat recovery exchanger 170 with the cold coolant stream.

Additionally, in some embodiments, the systems and processes claimed herein produce no CO₂ emissions from the heating process. Specifically, the systems and processes herein utilize electrical heating systems and processes, which result in no direct CO₂ production from the heating systems and processes, as compared to conventional systems that utilize combustion reactions to generate heat. These combustion reaction systems and processes conventionally burn methane or other gases, which produce CO₂ emissions. Although the product stream 310 may include CO₂, the systems and processes claimed herein produce no CO₂ emissions from the heating process.

### EXAMPLES

The following examples illustrate one or more embodiments of the present disclosure previously discussed. Additionally, a comparative example was conducted.

### Comparative Example A

A conventional upgrading process was determined where a feedstock was introduced into a preheater at 90° C. and heated to 149° C. A dilution steam stream was introduced to the dilution steam heat unit where the dilution steam stream was heated from an initial 175° C. to 465° C. The dilution steam stream was then mixed with the feedstock before the feedstock was sent to a first hydrocarbon heat unit, and heated the feedstock to 205° C. The feedstock was then introduced to the first hydrocarbon heat unit and was heated to 385° C..The feedstock was then sent to the second hydrocarbon heat unit and heated to 597° C. and sent to a reaction zone where it was heated and converted to form a product stream with a propylene/ethylene ratio of 0.51, resulting in an outlet temperature of 861° C. The product stream was then sent to 2 transfer line exchangers in series, and was cooled from 855° C. to 469° C. in the first transfer line exchanger and then cooled from 469° C. to 353° C. in the second transfer line exchanger. High pressure steam with a temperature of 310° C. was generated in the transfer line exchangers. The product stream was then sent to a heat recovery exchanger. The flue gas from the conventional combustion reaction zone was used to superheat the steam in steam superheater units 1 and 2, from 311° C. to 433° C. and from 391° C. to 490° C. respectively. Boiler Feed water going to the steam drum is pre-heated in the Economizer, from 120° C. to 202° C. The flue gas in this simulation is cooled down from 1187° C. to 136° C. The results of this simulation are summarized in Tables 1 and 2 below:

TABLE 1
Product stream temperature, flow rate, and
duty in a conventional upgrading process.

| | T in | T out | Flow | Duty |
|---|---|---|---|---|
| | C. | C. | MT/h | Gcal/hr |
| Preheater | 90 | 149 | 46.0 | 2.51 |
| Economizer | 120 | 202 | 57.7 | 4.91 |
| First hydrocarbon heat unit | 205 | 385 | 73.6 | 7.67 |
| Dilution Steam Unit | 175 | 465 | 27.6 | 4.05 |
| Steam Superheater Unit 1 | 310 | 433 | 56.6 | 6.36 |
| Steam Superheater Unit 2 | 391 | 490 | 59.3 | 3.91 |
| Second Hydrocarbon heat unit | 385 | 597 | 73.6 | 10.87 |
| | | | | Absorbed heat |
| Reaction Zone | 588 | 861 | 73.6 | 31.49 |
| Transfer Line Exchanger 1 | 855 | 469 | 73.6 | 20.08 |
| Transfer Line Exchanger 2 | 469 | 353 | 73.6 | 5.21 |
| High pressure steam | | | 59.298 | |

TABLE 2
Flue gas/steam temperature, flow rate, and
duty in a conventional upgrading process.

| | T in | T out | dT | Duty |
|---|---|---|---|---|
| | C. | C. | C. | Gcal/hr |
| Preheater | 208 | 136 | 72 | 2.51 |
| Economizer | 346 | 208 | 138 | 4.91 |
| First hydrocarbon heat unit | 554 | 346 | 208 | 7.67 |
| Dilution Steam Unit | 659 | 554 | 105 | 4.05 |
| Steam Superheater Unit 1 | 820 | 659 | 161 | 6.36 |
| Steam Superheater Unit 2 | 917 | 820 | 97 | 3.91 |
| Second Hydrocarbon heat unit | 1178 | 917 | 261 | 10.87 |
| | | | | Fired duty: |
| Reaction Zone | | | | 77.42 |
| Transfer Line Exchanger 1 | 310 | 310 | | 20.08 |
| Transfer Line Exchanger 2 | 310 | 310 | | 5.21 |

### Example 1

An upgrading process in accordance with the present disclosure was determined. A procedure similar to Comparative Example A was done, but there was no flue gas present in Example 1 because an electrically heated reaction zone was used (as opposed to the conventional combustion reaction zone of Comparative Example A) and the steam was instead heated using electric heaters since no flue gas was produced in Example 1. A feedstock was introduced into a preheater at 90° C. and heated to 149° C. A dilution steam stream was introduced to the dilution steam heat unit where the dilution steam stream was heated from an initial 175° C. to 465° C. The dilution steam stream was then mixed with the feedstock before the feedstock was sent to a first hydrocarbon heat unit, and heated the feedstock to 205° C. The feedstock was then introduced to the first hydrocarbon heat unit and was heated to 385° C. The feedstock was then sent to the second hydrocarbon heat unit and heated to 597° C. and sent to a reaction zone where it was heated to 861° C. to form a product stream. The product stream was then sent to 2 transfer line exchangers in series, and was cooled from 855° C. to 469° C. in the first transfer line exchanger and then cooled from 469° C. to 353° C. in the second transfer line exchanger. High pressure steam with a temperature of 310° C. was used in the transfer line exchangers. The product stream was then sent to a heat recovery exchanger. The results of this simulation are summarized in Table 3 below:

TABLE 3
Feedstock temperature, flow rate, and duty for Example 1.

| | Product feed | | | |
|---|---|---|---|---|
| | T in | T out | Flow | E-heat input |
| | C. | C. | MT/h | Gcal/hr |
| Preheater | 90 | 149 | 46 | 2.51 |
| Economizer | 120 | 202 | 57.7 | 4.91 |
| First Hydrocarbon heat unit | 205 | 385 | 73.6 | 7.67 |
| Dilution steam heat unit | 175 | 465 | 27.6 | 4.05 |
| Steam Superheater Unit 1 | 310 | 433 | 56.6 | 6.36 |
| Steam Superheater Unit 2 | 391 | 490 | 59.3 | 3.91 |
| Second Hydrocarbon heat unit | 385 | 597 | 73.6 | 10.87 |
| | | | | Absorbed heat |
| Reaction Zone | 588 | 861 | 73.6 | 31.49 |
| Transfer Line Exchanger 1 | 855 | 469 | 73.6 | 20.08 |
| Transfer Line Exchanger 2 | 469 | 353 | 73.6 | 5.21 |
| High Pressure Steam | | | 59.298 | |

### Example 2

An upgrading process in accordance with the present disclosure was determined. The reaction zone was heated electrically similar to Example 1, but Example 2 further utilized the product stream to heat the feed stream to maximize process efficiency. As a result of this change the intermediate temperatures of the feed stream and the product stream were further optimized. In Example 2, no high pressure steam was produced, as opposed to Comparative Example A and Example 1. For comparison reasons only, the equivalent shaft power per ton of produced high pressure steam was calculated for a 90 bar to condensing steam turbine. Using the calculated steam production from Example 1, an equivalent electrical power requirement for an electromotor was calculated and included as “High Pressure Steam Credit for Turbine” in the form of electrical power, as shown in Table 4. A feedstock stream 210 was introduced into a preheater 110 at 90° C. and heated to 224° C. to form a pre-heated hydrocarbon-based composition 220. A dilution steam stream 410 was introduced to the dilution steam heat unit 130 where the dilution steam stream 410 was heated from an initial 175° C. to 465° C. The dilution steam stream 410 was then mixed with the pre-heated hydrocarbon-based composition 220 before the mixed hydrocarbons based composition 225 was sent to a first hydrocarbon unit 120. The mixed hydrocarbon-based composition 225 was was then introduced to the first hydrocarbon heat unit 120 and was heated to 385° C. to create a heated hydrocarbon-based composition 230. The heated hydrocarbon-based composition 230 was then sent to a second hydrocarbon heat unit 140 and heated to 550° C. to form a hydrocarbon-based composition 240 and sent to an electric heater 150 and heated to 597° C. The hydrocarbon-based composition 240 was then sent to a reaction zone 160 where it was heated to 861° C. to form a product stream 310. The product stream 310 was then passed to the second hydrocarbon heat unit 140 where it heated the heated hydrocarbon-based composition 230 as described previously, and was thereby cooled from 855° C. to 692° C. The product stream 310 was then passed to the dilution steam heat unit 130 where the product stream 310 heated the dilution steam stream 410 as described previously, and was thereby cooled to 615° C. The product stream 310 was then sent to the first hydrocarbon heat unit 120 where the product stream 310 heated the pre-heated hydrocarbon-based composition 220 as described previously, and was thereby cooled to 528° C. The product stream 310 was then passed to the preheater 110 where the product stream 310 heated the feedstream 210 as described previously, and was thereby cooled to 401° C. The results of this simulation are summarized in Tables 4 and 5 below:

TABLE 4
Feedstock temperature, flow rate, and duty for Example 2.

| | T in | T out | Flow | Duty |
|---|---|---|---|---|
| | C. | C. | MT/h | Gcal/hr |
| Preheater | 90 | 224 | 46.0 | 5.70 |
| First Hydrocarbon heat unit | 280 | 385 | 57.7 | 4.48 |
| Dilution steam heat unit | 175 | 465 | 73.6 | 4.05 |
| Second Hydrocarbon heat unit | 385 | 550 | 73.6 | 8.46 |
| Electric Heater | 550 | 597 | 73.6 | 2.41 |
| Reaction Zone | 588 | 861 | 73.6 | 31.49 |

| | |
|---|---|
| Direct Electric Power | 33.90 |

| | |
|---|---|
| High Pressure Steam Credit For Turbine | 9.80 |
| Total electric power required | 43.70 |

TABLE 5
Product stream temperature, flow rate, and duty for Example 2.

| | T in | T out | Flow | Duty | T pinch | T salt |
|---|---|---|---|---|---|---|
| | C. | C. | MT/h | Gcal/hr | C. | C. |
| Preheater | 528 | 401 | 73.6 | 5.70 | 177 | 264 |
| First | 615 | 528 | 73.6 | 4.48 | 143 | 425 |
| Hydrocarbon | | | | | | |
| heat unit | | | | | | |
| Dilution | 692 | 615 | 73.6 | 4.05 | 150 | 505 |
| steam heat | | | | | | |
| unit | | | | | | |
| Second | 855 | 692 | 73.6 | 8.46 | 142 | 590 |
| Hydrocarbon | | | | | | |
| heat unit | | | | | | |

Pinch analysis is a methodology for minimizing energy consumption of chemical processes by calculating thermodynamically feasible energy targets (or minimum energy consumption) and achieving them by optimizing heat recovery systems, energy supply methods and process operating conditions. The pinch temperature is the minimum temperature difference (ΔT) between the feedstock and the product stream. The salt temperature is the temperature of the salt bath (which is equal to the feedstock temperature out plus the offset). The offset is the difference between the temperature of the salt bath and the inlet feedstock temperature. This energy balance is based on the worst case assumption of an isothermal temperature for the heat transfer fluid (salt bath), in other embodiments an temperature profile of the heat transfer fluid may be achieved, resulting in a higher minimum temperature difference (ΔT) between the feedstock and the product stream.

The energy consumption of each of Comparative Example A, Example 1, and Example 2 is shown in Table 6 below.

TABLE 6
A comparison of the energy consumption of Comparative
Example A, Example 1, and Example 2.

| | | High | | | |
|---|---|---|---|---|---|
| | | Pressure | | | |
| | | Steam | Electric | Electric | Total |
| | Fired | Generated | Heating | Motor | Electric |
| | Duty | Metric | Power | Power | Power |
| Comparison | Gcal/hr | Ton/hr | Gcal/hr | Gcal/hr | Gcal/hr |
| Comparative | 77.42 | 59.298 | 0 | 0 | 0.00 |
| Example A | | | | | |
| Example 1 | 0 | 59.298 | 71.77 | 0 | 71.77 |
| Example 2 | 0 | 0 | 33.90 | 9.80 | 43.70 |

| | | |
|---|---|---|
| Comparing Example 2 | 47% | 61% |
| to Example 1 | | |

Comparative Example A utilized a conventional combustion reaction zone and required 77.42 Gcal/hr of fired duty (power) to operate the reaction. The high pressure steam was generated in Comparative Example A by recovering the residual heat from the conventional fired furnace. Example 1, in which all heating was done electrically, as described previously, require 71.77 Gcal/hr of power, which was slightly less than Comparative Example A due to the elimination of stack losses. The high pressure steam was generated in Example 1 by recovering the residual heat from the electric heating. Example 2 did not include a high pressure steam stream because by using the product stream to heat the feed stream there was no residual heat. Example 2 exhibited a 61% reduction in electric power usage as compared to Example 1, which shows that utilizing the product stream to heat the feed stream to reduced the necessary power to operate the system from 71.77 Gcal/hr to 43.8 Gcal/hr (in other words, Example 2 requires 61% of the power required by Comparative Example A and Example 1, decreasing power consumption as compared to Comparative Example A and Example 1 by 39%).

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A process for upgrading a hydrocarbon-based composition comprising:
introducing the hydrocarbon-based composition into a reaction zone heated with electricity, concentrated solar radiation heat, nuclear reactor heat, geothermal heat, molten salt, molten metal, or combinations thereof;
heating the hydrocarbon-based composition in the reaction zone to create a product stream; and
cooling the product stream to create a cooled product stream, wherein:
the reaction zone does not produce flue gas.

2. The method of claim 1, further comprising pre-heating the hydrocarbon-based composition before heating the hydrocarbon-based composition in the reaction zone, wherein pre-heating the hydrocarbon-based composition comprises transferring heat from the product stream to the hydrocarbon-based composition, thereby cooling the product stream.

3. The method of claim 1, wherein cooling the product stream comprises:
transferring heat from the product stream to a dilution steam stream;
transferring heat from the product stream to the hydrocarbon-based composition; or
both.

4. The method of claim 1, further comprising:
introducing a feed stream into a feed pre-heat unit;
introducing the product stream into the feed pre-heat unit; and
pre-heating the feed stream in the feed pre-heat unit to create a pre-heated hydrocarbon-based composition and cooling the product stream in the feed pre-heat unit by transferring heat from the product stream to the feed stream.

5. The method of claim 4, further comprising:
introducing the pre-heated hydrocarbon-based composition into a first hydrocarbon heat unit;
introducing the product stream into the first hydrocarbon heat unit; and
heating the pre-heated hydrocarbon-based composition in the first hydrocarbon heat unit to create a heated hydrocarbon-based composition and cooling the product stream in the first hydrocarbon heat unit comprise transferring heat from the product stream to the pre-heated hydrocarbon-based composition.

6. The method of claim 5, further comprising:
introducing the heated hydrocarbon-based composition into a second hydrocarbon heat unit;
introducing the product stream into the second hydrocarbon heat unit; and
heating the heated hydrocarbon-based composition in the second hydrocarbon heat unit to create the hydrocarbon-based composition and cooling the product stream in the second hydrocarbon heat unit comprise transferring heat from the product stream to the heated hydrocarbon-based composition.

7. The method of claim 5, further comprising:
introducing a dilution steam stream into a steam unit;
introducing the product stream into the steam unit; and
cooling the product stream in the dilution steam heat unit by transferring heat from the product stream to the dilution steam stream.

8. The method of claim 1, wherein heating the hydrocarbon-based composition in the reaction zone to create a product stream comprises heating the hydrocarbon-based composition to a reaction temperature that ranges from 700° C. to 950° C., thereby cracking the hydrocarbon-based composition to create the product stream.

9. The method of claim 1, further comprising additionally cooling the cooled product stream with comprising molten salt, molten metal, organic fluid, inorganic fluid, or combinations thereof.

10. The method of claim 1, wherein the hydrocarbon-based composition comprises naphtha, ethane, propane, butanes, pentanes, atmospheric gas oil (AGO), vacuum gas oil (VGO), or combinations thereof; and the product stream comprises hydrogen, olefins, and aromatic hydrocarbons. In embodiments, the olefins comprise C₂ to C₅ olefins such as, for example, ethylene (C₂H₄), propylene (C₃H₆), butylene (C₄H₈), or combinations thereof.

11. A system for upgrading a hydrocarbon-based composition comprising:
a reaction vessel comprising a heating column,
a heat recovery exchanger comprising molten salt, molten metal, organic fluid, inorganic fluid, or combinations thereof, and
an electric heater, wherein:
the heating column is thermally connected to the electric heater; and
the heating column is thermally connected to the heat recovery exchanger.

12. The system of claim 11, further comprising a reaction zone, wherein the heating column comprises a pre-heat unit, a first hydrocarbon unit, a dilution unit, a second hydrocarbon unit, and a trim heater, a trim cooler, or both, wherein:
the first hydrocarbon unit is fluidly connected to the pre-heat unit, the dilution unit, and the second hydrocarbon unit; and
the second hydrocarbon unit is fluidly connected to the dilution unit, the first hydrocarbon unit, and the reaction zone.

13. The system of claim 11, wherein the heating column is solely heated via the electric heater.
